(19) United States
(12) Patent Application Publication
(10) Pub. No.: US 2010/0157360 A1
(43) Pub. Date: Jun. 24, 2010

(54) IMAGE FORMING APPARATUS AND TELEPHONE OPERATION SWITCHING METHOD THEREOF

(75) Inventor: Jeong-baek LEE, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/618,929

(22) Filed: Nov. 16, 2009

(30) Foreign Application Priority Data
Dec. 18, 2008 (KR) 10-2008-0129595

(51) Int. Cl. G06F 15/00; H04M 11/00

(52) U.S. Cl. 358/1.15; 379/90.01

(57) ABSTRACT

An image forming apparatus and a telephone operation regulating method thereof, the image forming apparatus including a main body that is connectable to an external telephone communication line; a receiver comprising an audio output unit and an audio input unit, connected to the main body; and a sensing unit disposed inside the receiver, to determine whether the receiver is in an on-hook state or an off-hook state.

### CROSS-REFERENCE TO RELATED APPLICATION

This application claims the benefit of Korean Patent Application No. 10-2008-0129595, filed on Dec. 18, 2008, in the Korean Intellectual Property Office, the disclosure of which is incorporated herein, by reference.

### BACKGROUND

1. Field

Aspects of the present teachings relate to an image forming apparatus and a telephone operation regulating method thereof.

2. Description of the Related Art

An image forming apparatus forms an image on a printing medium, and/or scans an image on a document. An image forming apparatus can be referred to as a scanner, a printer, an electronic copier, a facsimile, or a multifunction apparatus performing some or all of these operations.

The multifunction apparatus may include a receiver and a hook disposed on an upper side of a main body of the multifunction apparatus, to enable a telephone conversation. Also, the multifunction apparatus may further include a sensing unit to detect when the receiver is picked up from, or put down on, the main body.

However, such a sensing unit has a complicated configuration and high manufacturing costs. Also, since the hook is disposed on the main body of the multifunction apparatus, there is a design restriction in that the receiver is disposed on the main body, to operate the hook.

### SUMMARY

Accordingly, it is an aspect of the present teachings to provide an image forming apparatus and a telephone operation regulating method thereof, to sense whether a user is using a receiver.

Another aspect of the present teachings provides an image forming apparatus and a telephone operation regulating method thereof, which improves design freedom.

Still another aspect of the present teachings provides an image forming apparatus and a telephone operation regulating method thereof, which has reduced manufacturing costs.

The foregoing and/or other aspects of the present teachings are achieved by providing an image forming apparatus including: a main body that is connectable with an external telephone communication line; a receiver that comprises an audio output unit and an audio input unit, and is connected with the main body through a telephone line; and a sensing unit that is disposed inside the receiver, to sense whether the receiver is mounted to or detached from the main body.

According to some aspects, the apparatus may further include an electric power supply unit disposed inside the main body, to supply electric power to the audio output unit and the audio input unit.

According to some aspects, the sensing unit may output a sensing signal corresponding to whether the receiver is mounted on the main body, which is produced using electric power supplied to the receiver.

According to some aspects, the sensing unit may include a first switch that switches a voltage applied to the receiver and output to the main body, according to whether the receiver is mounted on or detached from the main body.

According to some aspects, the sensing unit may further include an actuator that moves between a first position and a second position to operate the first switch, according to whether the receiver is detached from or mounted on the main body.

According to some aspects, the sensing unit may further include an elastic member that elastically biases the actuator toward the first position.

According to some aspects, the apparatus may further include a control unit that determines whether the receiver is being used, based on an output of the sensing unit.

According to some aspects, the apparatus may further include a codec chip that converts an audio signal received through the external telephone communication line into a digital signal, and transmits a result input through an input and output port, to the control unit.

According to some aspects, the output signal of the sensing unit may be input to an input and output port of the codec chip.

According to some aspects, the apparatus may further include: a second switch that is disposed on an audio signal transmitting path between the receiver and the external telephone communication line, to regulate a telephone operation; and a control unit that controls the second switch to regulate the telephone operation, based on an output result of the sensing unit.

Another aspect of the present teachings provides a telephone operation regulating method of an image forming apparatus that comprises a receiver comprising an audio output unit and an audio input unit, the telephone operation regulating method including: transmitting a first sensing signal to a main body of the image forming apparatus, using electric power supplied to at least one of the audio output unit and the audio input unit, if a user detaches the receiver from the main body; turning on a telephone operation of the image forming apparatus; transmitting a second sensing signal to the main body, using the electric power, if a user mounts the receiver to the main body; and turning off the telephone operation of the image forming apparatus.

According to some aspects, the turning on the telephone operation may include connecting the receiver to an external telephone communication line.

According to some aspects, the turning off the telephone operation may include disconnecting the receiver from the external telephone communication line.

According to some aspects, the method may further include turning on the telephone operation, if a ring signal is detected from an external telephone communication line.

Additional aspects and/or advantages of the present teachings will be set forth in part in the description which follows and, in part, will be obvious from the description, or may be learned by practice of the present teachings.

### BRIEF DESCRIPTION OF THE DRAWINGS

These and/or other aspects and advantages of the present teachings will become apparent and more readily appreciated from the following description of the exemplary embodiments, taken in conjunction with the accompanying drawings, of which:

FIG. 1 is a schematic view of an image forming apparatus, according to an exemplary embodiment of the present teachings;

FIG. 2 is a main portion enlarged view showing a receiver of the image forming apparatus in FIG. 1, in an off-hook state;

FIG. 3 is a main portion enlarged view showing the receiver of the image forming apparatus in FIG. 1, in an on-hook state; and

FIG. 4 is a flowchart of a telephone operation regulating method of an image forming apparatus, according to an exemplary embodiment of the present teachings.

### DETAILED DESCRIPTION OF THE EXEMPLARY EMBODIMENTS

Reference will now be made in detail to the exemplary embodiments of the present teachings, examples of which are illustrated in the accompanying drawings, wherein like reference numerals refer to like elements throughout. The exemplary embodiments are described below, so as to explain the present teachings, by referring to the figures. Repetitive descriptions of like elements in different embodiments may be omitted for the convenience.

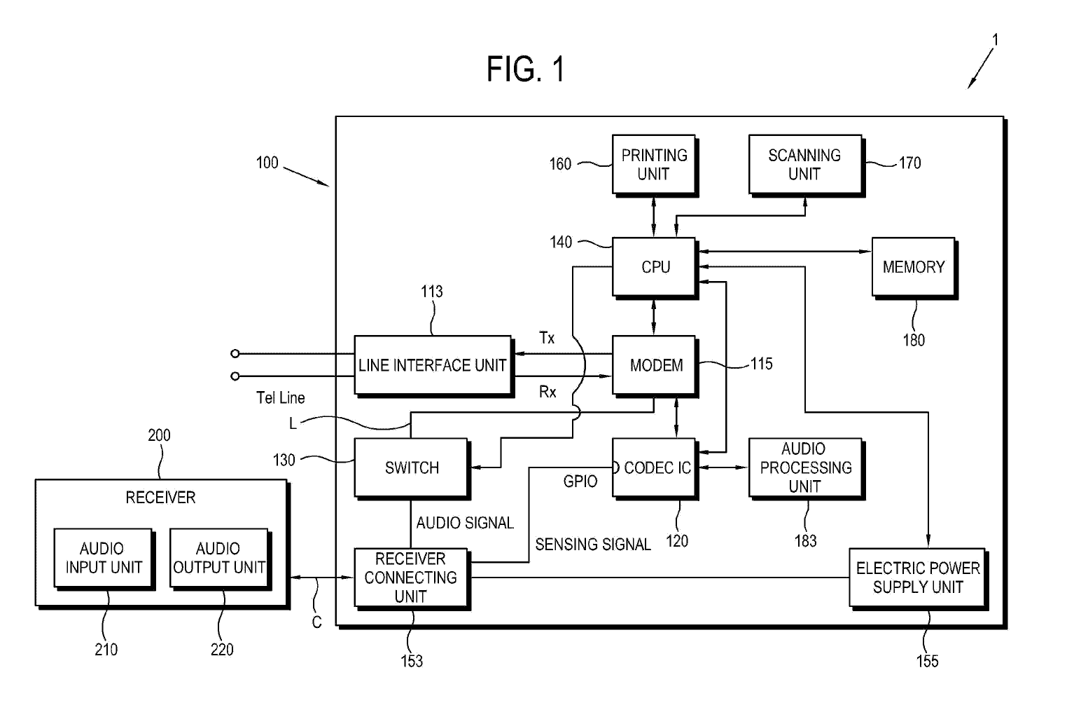

As shown in FIGS. 1 to 3, an image forming apparatus 1, according to an exemplary embodiment of the present teachings, includes a main body 100, a receiver 200 connectable to the main body 100 through, for example, a telephone line C or a wireless connection, and a sensing unit 230 disposed inside the receiver 200.

The main body 100 may be connected to an external telephone communication line (Tel-line). Audio signals and facsimile data may be received through the external telephone communication line.

The receiver 200 includes an audio input unit 210 to receive audio, and an audio output unit 220 to output audio. The audio input unit 210 may include a microphone, and the audio output unit 220 may include a speaker.

The receiver 200 is detachably mounted to a frame 101 of the main body 100. In more detail, a user may use the receiver by detaching the receiver 200 from the main body 100, which can be referred to as being in an “off-hook” state. The user may mount the receiver 200 to the main body 100, which can be referred to as being in an “on-hook” state. However, the receiver 200 can be in the on-hook and off-hook states, without being associated with the main body 100. For example, the receiver 200 can be placed in the on-hook state, without being mounted to the main body 100, as discussed below.

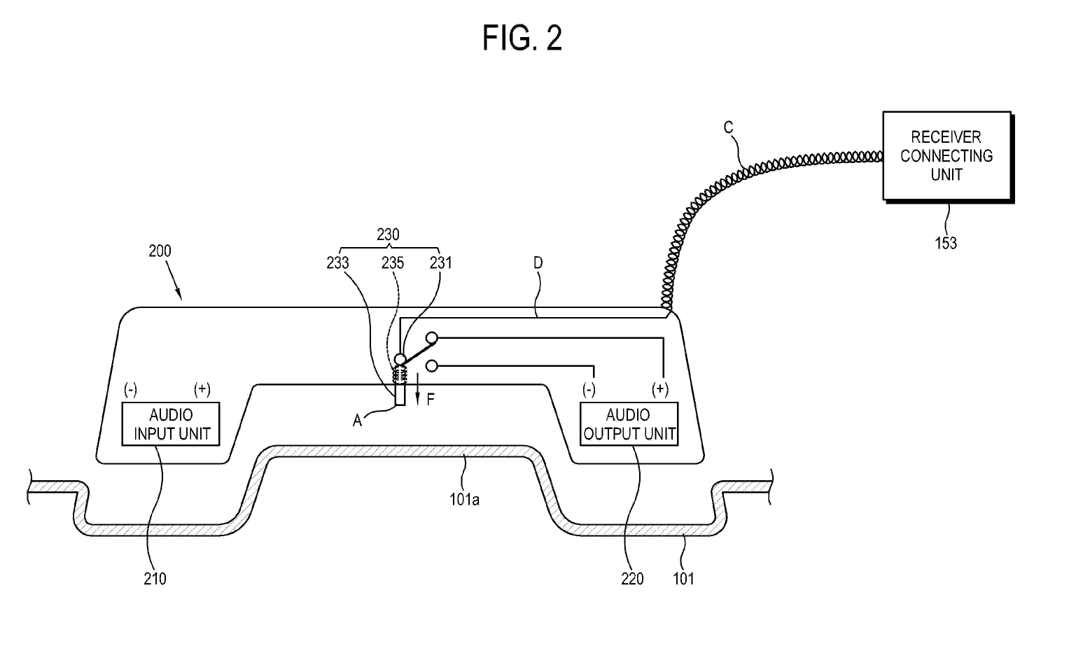

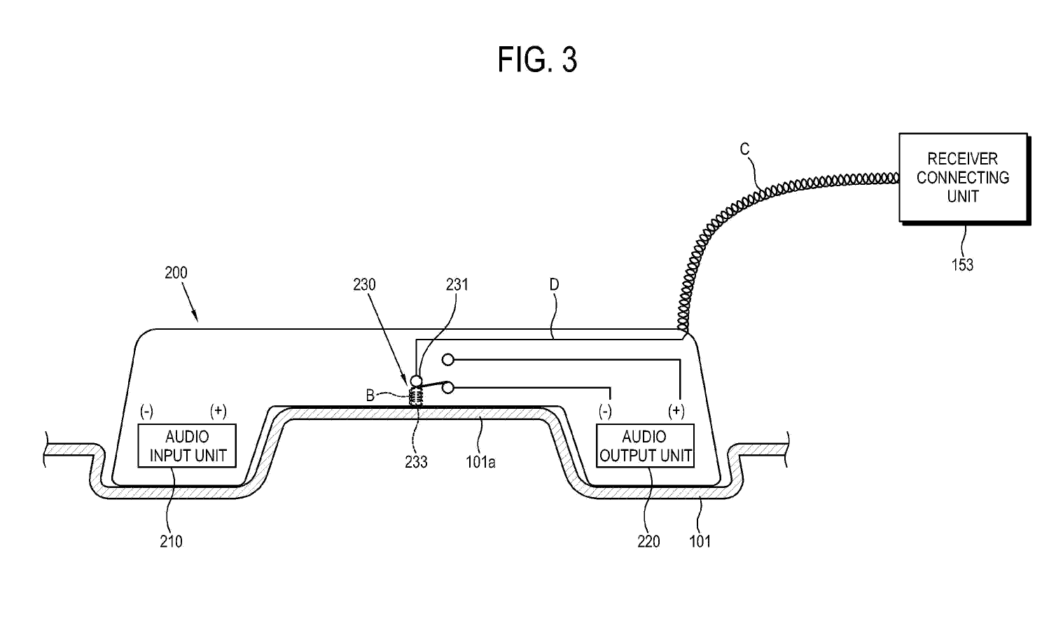

As shown in FIGS. 2 and 3, the sensing unit 230 transmits a sensing signal to the main body 100, according to whether the receiver is in the off-hook or on-hook state. In more detail, the sensing unit 230 includes a first switch 231 provided inside the receiver 200, to selectively apply power to the receiver 200.

As shown in FIG. 1, the image forming apparatus 1 may further include an electric power supply unit 155 to supply the power to the receiver 200, in order to drive the audio input unit 210 and the audio output unit 220. The electric power supply unit 155 receives alternating current (AC) and includes an AD/DC power converter to convert the AC into direct current (DC), which will be referred to herein, as a driving voltage. The driving voltage is applied to operate the audio input unit 210 and/or the audio output unit 220. The electric power supply unit 155 may include a battery instead of, or in addition to, the AD/DC power converter, to supply the driving voltage.

Also, as shown in FIG. 1, the electric power supply unit 155 is disposed inside the main body 100. According to some embodiments, the electric power supply unit 155 may be provided inside the receiver 200.

As shown in FIGS. 2 and 3, the first switch 231 is used to apply either the driving voltage or a ground voltage to the receiver 200, according to whether the receiver 200 is in the on-hook or off-hook state. The applied voltage is then transmitted to the main body 100, through, for example, the telephone line C connecting the receiver 200 to the main body 100. The applied voltages correspond to the sensing signal.

In particular, the first switch 231 may selectively apply the driving and ground voltages to the audio input unit 210 and/or the audio output unit 220. Alternatively, other voltages from the receiver 200 may be applied, as long as different voltages correspond to the on-hook or off-hook state of the receiver 200.

More in detail, if the receiver 200 is in the off-hook state, the first switch 231 may be used to apply a 3.3V driving voltage. Accordingly, the driving voltage is transmitted to the main body 100, as the sensing signal. On the contrary, if the receiver 200 is the on-hook state, the first switch 231 applies a 0V ground voltage, which is transmitted to the main body 100.

As shown in FIGS. 2 and 3, the sensing unit 230 may further include an actuator 233 to operate the first switch 231. That is, the operation of the first switch 231 may be interlocked with the movement of the actuator 233. The actuator 233 is disposed to the receiver 200, so as to move between a first position A and a second position B. In the first position A, the actuator 233 protrudes from the receiver 200. In the second position B the actuator 233 does not protrude from the receiver 200.

As shown in FIG. 2, if the receiver 200 is detached from the frame 101 of the main body 100, the actuator 233 moves to the first position A. As shown in FIG. 3, if the receiver 200 is mounted on the frame 101, the actuator 233 moves to the second position B.

The sensing unit 230 may further include an elastic member 235 to elastically bias the actuator 233 toward the first position A. The elastic member 235 may include a coil spring, a plate spring, or a combination thereof. The actuator 233 may be moved between the first position A and the second position B by a motor (not shown), instead of by the elastic member 235. If the receiver 200 is detached from the main body 100, a contact between the actuator 233 and a contact unit 101a of the frame 101 is withdrawn. Accordingly, the actuator 233 is moved to the first position A, by an elastic force F of the elastic member 235.

As shown in FIG. 2, as the actuator 233 moves to the first position A, the first switch 231 applies the driving voltage to the audio output unit 220, which can be output as the sensing signal, instead of the ground voltage. On the contrary, as shown in FIG. 3, if the receiver 200 is mounted to the main body 100, the actuator 233 contacts the contact unit 101a and is moved to the second position B, such that the first switch 231 applies the ground voltage to the audio output unit 220, which can be output as the sensing signal.

The sensing signal may be transmitted to the main body 100, through, for example, the telephone line C. In some aspects, the sensing signal can be transmitted wirelessly to the main body 100. Electric power lines that receive the driving voltage from the electric power supplying unit 155 may be included in the telephone line C.

The main body 100 may further include a control unit 140 to determine whether the receiver 200 is in the on-hook or off-hook state, based on the sensing signal transmitted from the receiver 200. Accordingly, the sensing unit 230 is disposed in the receiver 200 instead of the main body 100, thereby improving design freedom of the main body 100.

Since the sensing unit 230 is disposed inside the receiver 200, it is unnecessary to dispose the receiver 200 on a specific position of the main body 100, thereby improving a design freedom for the disposition of the receiver 200. The receiver 200 may be put into the on-hook state, while in a position other than on the main body 100, as long as the actuator 233 can be moved into the second position B. For example, the receiver 200 may be placed in the on-hook state, by being put down on a surface adjacent to the main body 100. Also, the on-hook and off-hook states of the receiver 200 can be sensed with this simple configuration.

The main body 100 further includes a modem 115, a line interface unit (LIU) 113, a codec integrated circuit (IC) 120, an audio processing unit 183, a receiver connecting unit 153, a printing unit 160, a scanning unit 170, and a memory 180. The main body 100 may further include a communicating unit (not shown) to receive printing data from a host apparatus, such as an external computer. The communicating unit may include at least one of a serial port, a parallel port, a universal serial bus (USB) port, and a network interface card (NIC).

The control unit 140 controls the modem 115 to demodulate data received from an external telephone communication line (Tel-line) and to modulate sensing data to be sent. The line interface unit 113 operates according to the control of the control unit 140, to form a loop of the external telephone communication line (Tel-line) and to interface a signal of the modem 115 and a signal of the external telephone communication line (Tel-line).

The codec IC 120 converts an audio signal modulated through the modem 115 into digital audio data. The audio processing unit 183 compresses the digital audio data, and the control unit 140 stores the compressed audio data in the memory 180. The receiver connecting unit 153 interfaces the main body 100 and the receiver 200. The telephone line C is connected to the receiver connecting unit 153.

An audio signal received from the external telephone communication line (Tel-line) is sent to the audio output unit 220, through the modem 115 and the receiver connecting unit 153. An audio signal input through the audio input unit 210 is transmitted to the external telephone communication line (Tel-line), through the modem 115 and the receiver connecting unit 153.

The driving voltage generated by the electric power supplying unit 155 is supplied to the audio input unit 210 and the audio output unit 220, via the telephone line C and the receiver connecting unit 153. The sensing signal of the sensing unit 230 is input to a general purpose input and output (GPIO) port of the codec IC 120, through the receiver connecting unit 153. The codec IC 120 transmits the sensing signal of the GPIO port, to the control unit 140.

The main body 100 of the image forming apparatus 1 may further include a second switch 130 disposed on a transmission path L between the modem 115 and the receiver connecting unit 153, to regulate a telephone operation, such as the transmission of an audio signal. The second switch 130 may control the transmission of the audio signal through the transmission path L, by opening and closing the transmission path L. The second switch 130 is shown to be disposed between the modem 115 and the receiver connecting unit 153, but may be disposed on a transmission path between the line interface unit 113 and the receiver connecting unit 153.

If the transmission of the audio signal is allowed through the transmitting path, an audio conversation is possible, and the telephone operation is turned on. If the transmission of the audio signal is not allowed, an audio conversation is impossible, and the telephone operation is turned off. The control unit 140 controls the second switch 130 to turn on the telephone operation, if a high signal is received by the GPIO port of the codec IC 120.

More in detail, the high signal is received by the GPIO port, when the receiver 200 is in the off-hook state and the sensing unit 230 outputs the driving voltage as the sensing signal. That is, if a user picks up the receiver 200, the high signal is input to the GPIO port of the codec IC 120, the telephone operation is turned on, and the user can conduct a conversation.

On the contrary, the control unit 140 controls the second switch 130 to turn off the telephone operation, if a low signal is received by the GPIO port of the codec IC 120. In more detail, the low signal is received by the GPIO port when the receiver 200 is in the on-hook state, and the sensing unit 230 outputs the ground voltage as the sensing signal.

That is, if a user puts down the receiver 200, the low signal is input to the GPIO port of the codec IC 120, and the telephone operation is turned off. When the telephone operation is the turned off state, the control unit 140 determines whether a ring signal is detected through the line interface unit 113. If the ring is detected in the line interface unit 113, the control unit 140 controls the second switch 130, such that the telephone operation is turned on.

If a facsimile transmission command is received through an operation panel (not shown), the control unit 140 controls the scanning unit 170 to scan an image recorded on a document, and controls the modem 115 to modulate the scanned image data and to transmit the modulated data to the external telephone communication line (Tel-line). The printing unit 160 prints facsimile data received through the external telephone communication line (Tel-line), depending on a control command of the control unit 140. The control unit 140 may control the printing unit 160 to print the image data scanned by the scanning unit 170, if a copying command is received.

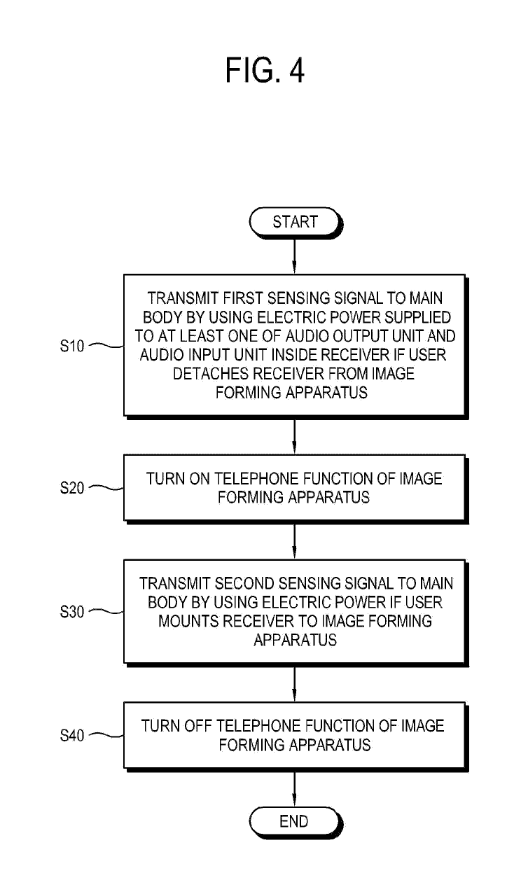

Hereinafter, a telephone operation regulating method of the image forming apparatus 1, according to the exemplary embodiment of the present teachings, will be described by referring to FIGS. 1 and 4. If a user detaches the receiver 200 from the main body 100, or otherwise places the receiver 200 in the off-hook state, a first sensing signal is transmitted to the main body 100, using a voltage from at least one of the audio output unit 200 and the audio input unit 210 of the receiver 200 (S10).

The first sensing signal may be a driving voltage and/or a ground voltage. As described above, the first sensing signal may be a high signal (for example, a 3.3V signal). Then, a telephone operation of the image forming apparatus 1 is turned on (S20). The telephone operation may be turned on by connecting an audio signal transmitting path, between the receiver 200 and the external telephone communication line (Tel-line), so that an audio signal can be transmitted therebetween.

If the user mounts the receiver 200 on the main body 100, that is, places the receiver 200 in the on-hook state, a second sensing signal is transmitted to the main body 100, using the voltage supplied to at least one of the audio output unit 220 and the audio input unit 210 (S30). Here, the second sensing signal may be the other of the driving voltage and the ground voltage. As described above, the second sensing signal may be a low signal (for example, a 0V signal).

The telephone operation of the image forming apparatus 1 is turned off (S40). The telephone operation may be turned off by disconnecting the audio signal transmitting path, between the receiver 200 and the external telephone communication line (Tel-line), so that an audio signal is prevented from being transmitted therebetween. The telephone operation regulating method may further include turning on the telephone operation, if a ring signal is detected from the external telephone communication line (Tel-line).

As described above, an image forming apparatus and a telephone operation regulating method thereof may have the following effects. First, a simple configuration can be used to detect whether a receiver is in an on-hook or off-hook state. Second, a sensing unit is provided inside the receiver itself, so that the receiver can be freely disposed. Third, a voltage supplied to a speaker or a microphone is used to detect the state of the receiver, thereby reducing manufacturing costs.

Although a few exemplary embodiments of the present teachings have been shown and described, it will be appreciated by those skilled in the art that changes may be made in these exemplary embodiments, without departing from the principles and spirit of the present teachings, the scope of which is defined in the appended claims and their equivalents.

What is claimed is:

1. An image forming apparatus, comprising:
a main body that is connectable to an external telephone communication line;
a receiver comprising an audio output unit and an audio input unit, connected to the main body through a telephone line; and
a sensing unit disposed inside the receiver, to output a sensing signal to the main body, according to whether the receiver is in an on-hook state or an off-hook state.

2. The image forming apparatus according to claim 1, further comprising an electric power supply unit to supply a driving voltage to the receiver, to drive the audio output unit and the audio input unit,
wherein the sensing unit outputs the sensing signal based on a voltage supplied to the receiver.

3. The image forming apparatus according to claim 2, wherein the sensing unit comprises a first switch disposed in the receiver, to selectively establish a connection between the telephone line and the driving voltage or a ground voltage applied to the receiver.

4. The image forming apparatus according to claim 3, wherein the sensing unit further comprises an actuator that moves between a first position and a second position to operate the first switch, according to the on-hook state or off-hook state of the receiver.

5. The image forming apparatus according to claim 4, wherein the sensing unit further comprises an elastic member to elastically bias the actuator toward the first position.

6. The image forming apparatus according to claim 1, further comprising a control unit to determine whether the receiver is in the on-hook state or off-hook state, based on a signal output from the sensing unit.

7. The image forming apparatus according to claim 6, further comprising a codec chip to convert an audio signal received through the external telephone communication line into a digital signal, and to transmit a result input through an input and output port to the control unit,
wherein the signal transmitted from the sensing unit is input to an input and output port of the codec chip.

8. The image forming apparatus according to claim 1, further comprising:
a second switch disposed on an audio signal transmitting path between the receiver and the external telephone communication line, to regulate telephone operations, and
a control unit to control the second switch, based on an output result of the sensing unit.

9. A telephone operation regulating method of an image forming apparatus that comprises a main body and a receiver comprising an audio output unit and an audio input unit, the method comprising:
transmitting a first sensing signal to the main body, using power supplied to the receiver to drive at least one of the audio output unit and the audio input unit, if the receiver is in an off-hook state;
turning on a telephone operation of the image forming apparatus, according to the first sensing signal;
transmitting a second sensing signal to the main body using the power, if the receiver is in an on-hook state; and
turning off the telephone operation of the image forming apparatus, according to the second sensing signal.

10. The method according to claim 9, wherein:
the turning on the telephone operation comprises connecting the receiver and an external telephone communication line; and
the turning off the telephone operation comprises disconnecting the receiver from the external telephone communication line.

11. The method according to claim 9, further comprising turning on the telephone operation, if a ring signal is detected from an external telephone communication line.

12. An image forming apparatus, comprising:
a main body that is connectable to an external telephone communication line;
a receiver comprising an audio output unit and an audio input unit, connected to the main body through a telephone line;
an electric power supply unit to supply a driving voltage to the receiver, to drive the audio output unit and/or the audio input unit;
a sensing unit disposed inside the receiver, to output a sensing signal to the receiver, according to whether the receiver is in an on-hook state or an off-hook state, using the driving voltage or a ground voltage applied to the receiver; and
a control unit to determine whether the receiver is in the on-hook state or off-hook state, based on the sensing signal.

13. The image forming apparatus of claim 12, wherein the sensing unit comprises:
a first switch disposed in the receiver, to selectively establish a connection between the telephone line and the driving voltage or the ground voltage; and
an actuator to operate the first switch, according to the on-hook state or off-hook state of the receiver.

14. The image forming apparatus according to claim 13, wherein the sensing unit further comprises an elastic member to elastically bias the actuator toward a first position, such that the first switch is connected to the driving voltage, when the receiver is in the off-hook position.

15. The image forming apparatus according to claim 12, wherein the sensing signal comprises the driving voltage and the ground voltage.
